(19) United States
(12) Patent Application Publication
(10) Pub. No.: US 2003/0168758 A1
(43) Pub. Date: Sep. 11, 2003

(54) Plastic color blender and method

(76) Inventor: Jeffrey L. Bickel, Oil City, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/093,066

(22) Filed: Mar. 7, 2002

(51) Int. Cl. B29B 7/72

(52) U.S. Cl. 264/40.1; 425/145

(57) ABSTRACT

A plastic color blender and method for making colored plastic resin material can include multiple differently colored color additives provided for use with a plastic processing machine so that base resin material can be custom colored at the processing machine. One or more of the multiple differently colored color additives can be selectively dispensed for mixing with and coloring the base resin material. The color additives can be dispensed by one or more metering devices in correct proportion to obtain the desired color and in correct volume to match the throughput rate of the plastic processing machine. The coloring of the resin material can be checked and the dispensation of the color additives adjusted to obtain the desired color.

### BACKGROUND

The invention relates to the coloring of plastic materials, and more particularly to a plastic color blender and method capable of coloring plastic material at a plastic processing machine simultaneously with processing the plastic material.

Plastic materials are increasingly being utilized in a wide range of markets and in a variety of applications in diverse manufacturing fields. Plastic materials offer many desirable characteristics such as an excellent finish, desirable electrical, thermal and mechanical properties, low-cost, and can be produced in a wide variety of colors. In the field of polymer design there is an increasing demand for color polymer blend techniques to faithfully reproduce blend colors. The color of the final product may depend on several factors including the concentration and type of colorant and base resin, temperature history during mixing, and the ultimate degree of constituent inter-mixing achieved during processing. Thus, variations in color between polymer products may arise for a variety of reasons. For example, color may vary among products due to polymer product formulation or recipe differences. Color variations may exist between lots for a given product formulation or recipe due to machine-to-machine differences. Color differences may exist within lots due to changing raw material characteristics, changing operating conditions, and inaccuracies and other anomalies in processing, including speed rates.

Polymer color is typically manually adjusted by adjusting the amount of colorant for a given production run. The colorant may take any conventional form which affects the color of the polymer product by itself or in combination with other constituents. For example, solid pigments and liquid pigments or dyes may be used for affecting the color of the final product.

In a typical coloring production process, a color additive, or colorant, is first developed having the desired color. The colorant is added in small amounts to a base resin, in which the colorant is blended and then compounded or extruded in a laboratory machine to generate pellets. The pellets are then injection molded to obtain a plaque with substantially uniform color, which is then conventionally measured in a laboratory spectrocolorimeter. The measured plaque color is compared with the desired color, which may be a reference plaque having a standard color or a particular reference color from a customer. Any differences between the color of the measured plaque color and reference plaque color are corrected by adjusting the colorant. This sequence is repeated until the measured plaque color falls within an acceptable range to the reference plaque color. A sample of the finally corrected colorant and resin blend is then compounded on a production scale machine that follows the same procedure as the laboratory machine to produce a color plaque which is again compared with the reference plaque. If required, the color in the production machine is suitably corrected to affect an acceptable match between the measured plaque and the reference plaque. When an acceptable match has been achieved, a batch of resin is produced for customers. As can be understood, this process requires many steps to achieve a desired color in the polymer pellets, which increases processing time and cost.

Accordingly, when colored plastic products are desired to be molded, the color additive is first developed and then blended with a base resin to produce the colored resin pellets which can be used to produce the colored plastic parts. Alternatively, some plastic product producers can created colored resin on site in a manner similar to that described above used to create colored plastic resin material. In either case, there are basically three different methods in the prior art by which plastic resin can be colored in the manner described above: (1) adding dry color (powder pigment) to the base resin and blending them together; (2) adding liquid color (pigment slurry) to the base resin and blending them together; and, most commonly, (3) adding color concentrated pellets to the base resin and blending them together. Color concentrated pellets are pellets wherein pigment has been compounded into a base resin prior to pelletizing, in accordance with the method described previously involving adding colorant and comparing the colored resin to a reference plaque until the color match is acceptable. In any coloring method, the color additives must be blended with base resin to obtain specific colors: primary colors (such as blue, red, and yellow), secondary colors (such as purple, green, and orange produced by mixing primary colors); and tertiary colors (such as gray, and brown, produced by mixing secondary colors).

Moreover, in each case, a colorant having the desired color is first developed and thereafter blended with base resin upstream of the processing machine. In the most commonly employed method of producing colored plastic products, color concentrated pellets are blended with natural colored plastic pellets in a hopper. The blended pellets are then fed into a processing machine which melts the blended plastic material and produces a colored end product by various well known methods, including extrusion, injection molding and blow molding. Injection molding is a method of producing plastic parts by injecting melted plastic into a mold. Extruding is a method of producing plastic shapes by pushing melted plastic through a die. Blow molding is a method of producing plastic parts by injecting or extruding melted plastic into a mold, then blowing air into the plastic to expand the plastic into the shape of the mold.

There are generally two common disadvantages of all of the conventional plastic coloring methods described above. First, conventional plastic coloring methods require plastic product producers, e.g., manufacturers, to acquire a specific color additive for each desired end color plastic part. As a result, pre-colored plastic material must be ordered in advance. This can require manufacturers to buy and inventory many different colors of pre-colored plastic material. The second disadvantage is that the coloring of the plastic material is performed upstream of the plastic processing machine. Thus, changing from one color to another color can be time consuming and wasteful of plastic material. As a result, other disadvantages associated with expense, inventory and delay are created.

Accuracy, consistency, and repeatability of the color of the end products is a chief concern. It is important that the desired color can be reproduced consistently. Moreover, each individual end product produced from the same batch of pre-colored plastic material should be consistently colored. Problems with inconsistent coloring of products can occur when the color additives, for example, color concentrated pellets, are not sufficiently dispersed in the natural colored pellets. In other words, the color additives are not evenly distributed throughout the natural colored material (non-homogenous blend). For example, even though the color additives and natural colored material are proportioned together correctly, some of the color additive may aggregate in higher concentration in parts of the blended batch of material. This results in inconsistent coloring of the end products. Additionally, color variation can occur due to polymer product formulation or recipe differences. Color variations can also occur for a given product formulation or recipe due to machine-to-machine differences, changing raw material characteristics, changing operating conditions, or inaccuracies and other anomalies in processing, including speed rates.

In view of the disadvantages which can be associated with the prior art methods of making colored plastic products, a plastic color blender and method for coloring resin at individual plastic processing machines can be desirable to eliminate the conventional need to specify, buy and inventory every color required to make particular products. Moreover, it can also be desirable that the plastic color blender and method provide the capability to check to the color of the end product to determine if it matches the desired color, and to adjust the coloring process if it does not.

### SUMMARY

A plastic color blender and method is provided for use with a plastic processing machine so that generally uncolored base resin material can be colored to practically any desired color at the plastic processing machine. A plurality of differently colored color additives are provided, of which one or more can be selective dispensed into the base resin material at the plastic processing machine to cause the base resin material to take on the desired color. The color additives can be dispensed into the base resin material as part of a single overall process for making colored plastic products. One or more metering devices can be employed to control dispensing of the differently colored additives into the base resin material. Customized coloring of the base resin material can thereby be carried out at practically the same time the colored plastic products are being produced. The color additives can include the primary colors, and also black and white. Thus, secondary and tertiary colors can easily be created simply by mixing appropriate ones of the differently colored color additives. Moreover, a device for checking the color of the colored resin material produced at the plastic processing machine can be provided to ensure that the color matches the desired color. Feedback from the color check device can be used by a controller which can regulate the metering device dispensing the color additives to efficiently achieve the desired color. Feedback from the plastic processing machine, for example representative of the throughput rate, can also be provided to the controller so that the dispensation of the color additives can be metered in correct proportions to result in the desired color, and also in proper volumes to match the throughput rate of the plastic processing machine. The plastic processing machine can be of a conventional type having a resin feeder portion and a plasticizing portion wherein the resin is reduced to a molten state and thereafter fed toward a discharge portion of the plastic processing machine where it is formed into a desired end product. The plastic processing machine can function according to any of the well known methods described above, namely—injection molding, extrusion, and blow molding. The color additives can be dispensed into the molten flow of base resin in the plasticizing portion and mixed therein, or can be mixed with the base resin prior to it being rendered molten in the plasticizing portion. To control dispersion of each of the differently colored color additives, a separate metering device can be provided for each color. The metering devices can be electrically controllable metering pumps individually operable by the controller. The color checking device can be, for example a type of spectrometer, such as a spectrocolorimeter, or like type of device adapted for this application. Other components can include static or dynamic mixers to provide additional blending of the color additives with the uncolored plastic material, before and/or after the resin is rendered molten. Additionally, another such mixer can be provided to pre-mix the color additives before being dispensed into the base resin.

Other details, objects, and advantages of the invention will become apparent from the following detailed description and the accompanying drawings figures of certain embodiments thereof.

### BRIEF DESCRIPTION OF THE DRAWING FIGURES

A more complete understanding of the invention can be obtained by considering the following detailed description in conjunction with the accompanying drawing, in which:

FIG. 1 illustrates a presently preferred embodiment of a plastic color blender used in conjunction with a plastic processing machine.

FIG. 2 illustrates a prior art blender.

### DETAILED DESCRIPTION OF CERTAIN EMBODIMENTS

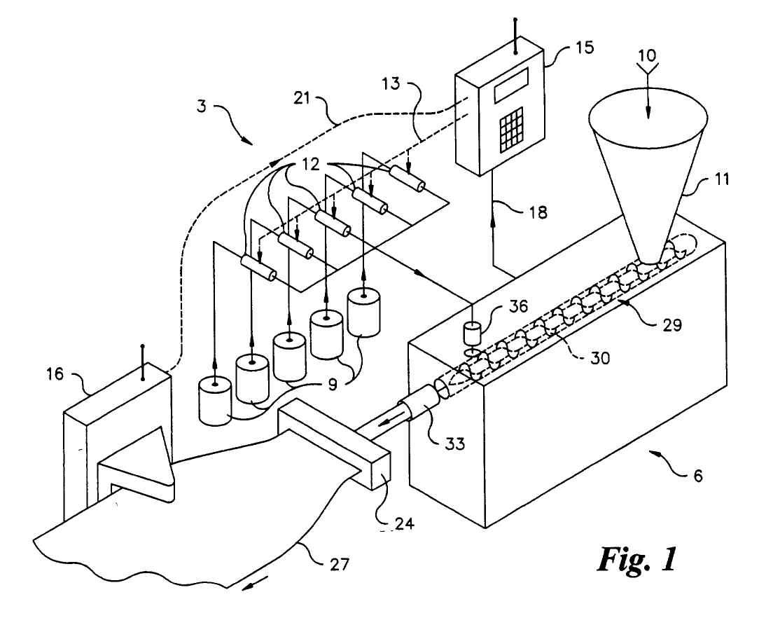

Referring to FIG. 1, a plastic color blender 3 is illustrated as it can be employed with a conventional plastic processing machine 6. The plastic color blender 3 can include individual containers of color additives 9 for coloring base resin material 10 which can be fed into the plastic processing machine 6 via a feeder portion 11, which can be a chute, hopper, or the like. Dispensing of the color additives 9 can be regulated by one or more additive metering devices 12, for example electrically controllable metering pumps, operated by a controller 15. A color checking device 16, which can be positioned at an output, or discharge portion 24 can also be utilized. The color additives 9 can preferably be in liquid form, although the plastic color blender 3 could be adapted to utilize dry color additives 9. The color additives 9, can include the primary colors—blue, red, and yellow. Black and white color additives can also be included. The additives can be purchased and stored in individual container, such as in five gallon pails or small drums. The controller 15 can operate the metering pumps 12 via output signal 13 to meter the color additives 9 into a supply of base resin material 10 which is to be colored. Color additives 9 can be dispensed individually, either a single color, or in combinations of colors to create secondary to tertiary colors, to mix with the base resin material 10.

In the presently preferred embodiment of the invention shown, the color additives 9 are dispensed into the base resin 10 in the plasticizing portion 29 of the plastic processing machine 6 after the base resin has been rendered a molten flow, such as by, for example, a plasticizing screw 30. However, the color blender 3 could be alternatively configured in association with the plastic processing machine 6 such that the color additives 9 were dispensed into the base resin 10 prior to feeding the base resin 10 into the plasticizing portion 29. The controller 15 can cause the metering pumps 12 to dispense the color additives 9 in the correct proportions to give the desired color, and in the correct volumes to match the throughput rate of the processing machine 6. As shown, preferably each container of the color additives 9 can be associated with an individually controllable metering pump 12. Although five color additives 9 and five metering pumps 12 are illustrated, more, or less, could be satisfactorily utilized. Each of the metering pumps 12 can be individually operated via output 13 from the controller 15. It will also be understood to those of skill in the art that an appropriately designed system could be devised which would permit a single metering pump to selectively control individual ones of the multiple metering pumps 12.

The controller 15 can also receive an input signal 18 from the processing machine 6, which can communicate information about the operating parameters of the processing machine 6, for example, the prevailing throughput rate of the processing machine 6. The controller 15 can use such feedback to control the metering pumps 12 to cycle or ramp up/down in order to match the throughput rate at which the processing machine 6 is being operated. The controller 15 can also receive an input signal 21 from the color checking device 16 which checks the color of the colored resin material, such as output 27, i.e., colored plastic resin material discharged from the output/discharge portion 24 of the plastic processing machine 6. The color checking device 16 can be, for example, a spectrometer type of device, such as a spectrocolorimeter, or like type of device specifically adapted for determining the color of the colored plastic resin material 27. A spectrocolorimeter is an optical device used for measuring wave lengths of light that determine the color of an article. Feedback signal 21 from the color checking device 16 can be provided to the controller 15 for making adjustments to the coloring process to assure color match quality control. In particular, the feedback signal 21 can be used by the controller 15 to regulate the metering pumps 12 for adjusting the proportions of the color additives 9 dispensed for mixing with the natural colored, generally uncolored, base resin material 10 to cause the color of the colored plastic resin material 27 to match the desired color. The controller 15 can make such adjustments during operation of the plastic processing machine 6, thus regulating the process dynamically to produce the desired color resin material 27 in an efficient manner. The color checking device 16 can be used both to perform color matching at the start of the process and to monitor the color of the colored plastic resin material 27 during processing for closed loop quality control over the coloring operation.

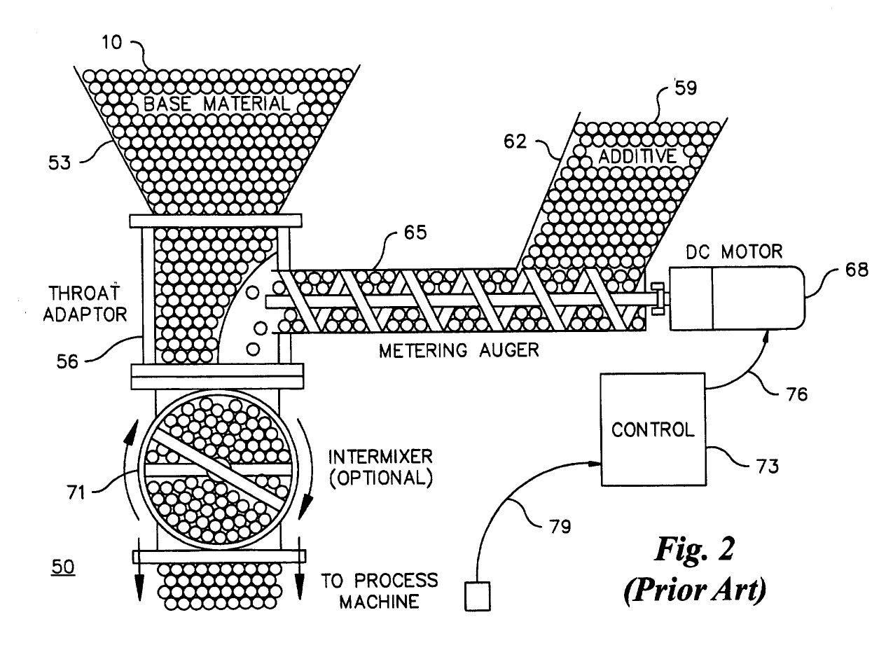

Referring now to FIG. 2, to a prior arty type blender 50 is shown to better illustrate the differences between the plastic color blender 3 according to the invention and the prior art. In conventional practice, a prior art type blender 50 connects to a plastic processing machine, such as the plastic processing machine 6 in FIG. 1, and would be attached to the plastic processing machine 6 in place of the chute 11. The prior art blender 50, for example, includes of a first hopper/chute 53 which feeds generally uncolored plastic material 10 into a throat portion 56. In this simplified schematic, a color additive 59 is contained in a second hopper/chute 62 and is dispensed into the throat portion 56 via a metering auger 65 which can be driven by a motor 68. The color additive 59 and generally uncolored plastic material can fed from the throat portion 56 into a plasticizing portion of a plastic processing machine, neither of which are shown, but which can be the same as the plasticizing portion 29 of the plastic processing machine 6 in FIG. 1. In the particular prior art blender 50 shown, an intermixer 71 is also provided for mixing the color additive 59 with the base resin material 10 prior to being fed into the plasticizing portion of a plastic processing machine. The motor 68 for driving the metering auger 65 can be controlled by a controller 73 via control signal 76. The motor 68 can also receive output signal 79 from the plastic processing machine to which the blender 50 can be connected. Although the prior art blender 50 is shown configured to utilize dry color additives 59, the motor 68 driven metering auger 65 could be replaced with a pump (not shown) for dispensing a liquid color additive into the throat portion 56, or intermixer 71, for mixing with the base resin material 10. Nevertheless, whether dry or liquid, the color additive is a single specific color developed to create a specifically colored resin for use in producing products of that particular color. Additionally, the single color additive is mixed with the base resin to prior to being delivered into the plasticizing portion of a plastic processing machine, and the manner of obtaining the desired color plastic resin material is generally in accordance with the prior art manner of coloring plastic material as described heretofore.

In contrast, the plastic color blender 3 according to the invention can be utilized with a plastic processing machine 6 to dispense one or more color additives 9 into the base resin material 10 in controllable proportions to create customized secondary or tertiary colors at the plasticizing machine at the time of production. In this way custom colored plastic resin material can be produced on site without having to specify and order each particular desired color in advance of production. In a preferred embodiment of the color blender 3 the color additives 9 can be dispensed into the molten flow of base resin 10 created in the plasticizing portion 29 of the plastic processing machine 6. In this manner, the color additives 9 can be sufficiently mixed with the molten flow of base resin 10 as it is fed towards the discharge portion 24 by the plasticizing screw 30. However, if needed or desired in certain applications or under certain conditions, additional mixing of the color additives 9 with the melted uncolored plastic material 10 can be accomplished by providing a static or dynamic mixer 33 between the plasticizing portion 29 and the discharge portion 24 of the plasticizing machine 6 where the colored plastic resin material 27 is discharged. The mixer 33 further blends the dispensed color additives 9 with the molten base resin 10 subsequent to the plasticizing portion 29 to assure consistent coloring of the discharged colored plastic resin material 27. The discharge portion 24 can be configured according to well know types of plastic processing machines as described heretofore, including injection molding, extruding, and blow molding, in order to create colored plastic end products of various types and designs.

Further embodiments of the color blender 3 can include pre-mixing of the color additives 9 with a second static or dynamic mixer 36 prior to dispensing the color additives 9 for mixing with the base resin 10 material. In the color blender 3 illustrated in FIG. 1, the mixer 36 is positioned intermediate the color additives 9 and the plasticizing portion 29 of the plastic processing machine 6. This additional mixing can be utilized to assure homogeneity of the color additives 9 before mixing with the base resin material 10. Pre-mixing of the color additives 9 may desirable, for example, where the color to be provided is a secondary or tertiary color.

Alternatively to dispensing the color additives 9 into the plasticizing portion 29 to mix with the molten base resin 10, the plastic color blender 3 could instead be configured so that the color additives 9 are mixed with the base resin 10 prior to the plasticizing portion 29. For example, the metering pumps 12 could dispense the color additives 9 into a throat adapter 56, or intermixer 71, or like member, for mixing with the base resin material 10 prior to it being reduced to a molten state.

A presently preferred embodiment of a method of coloring plastic resin material, in its most basic form, can generally comprise (1) providing a plurality of differently colored color additives; and (2) selectively dispensing one or more of the differently colored color additives 9 into a base resin material 10 for mixing therewith, either after or before the base resin material 10 has been reduced to a molten state in the plasticizing portion 29 of a plastic processing machine, to thereby create a colored plastic resin material of a desired color. This method enables production of virtually any desired color of colored plastic resin material at the processing machine, thus eliminating the conventional need to specify and order in advance each and every particular color of resin material needed to produce colored plastic products.

Other presently preferred embodiments can include additional steps such as checking the color of the colored plastic resin material 27 to determine whether it matches the desired color, and adjusting the dispensation of the color additives if the color does not match. These steps can be carried out during operation of the plastic processing machine 6 to dynamically control the process to efficiently adjust the color of the colored plastic resin material 27 to cause it to match the desired color. Additional steps can include: (1) mixing of dispensed color additives 9 with the base resin material 10 after it has been rendered molten in the plasticizing portion 29; and (2) mixing of the color additives 9 prior to dispensation into the base resin 10. Moreover, the process can be controlled using feedback, including feedback 18 indicative of the throughput rate of the plastic processing machine 6, and feedback 21 indicative of the color of the colored plastic material 27.

Although certain embodiments of the invention have been described in detail, it will be appreciated by those skilled in the art that various modifications to those details could be developed in light of the overall teaching of the disclosure. Accordingly, the particular embodiments disclosed herein are intended to be illustrative only, and not limiting to the scope of the invention which should be awarded the full breadth of the following claims and any and all embodiments thereof.

What is claimed is:

1. A plastic color blender for use with a plastic processing machine having a feed portion and a plasticizing portion, said plastic color blender comprising:
a. base resin material in communication with said feed portion;
b. a plurality of differently colored color additives;
c. a metering device intermediate said base resin material and said plurality of differently colored color additives; and
d. a controller causing said metering device to selectively dispense at least one of said plurality of differently colored color additives into said base resin material to cause said base resin material to become a desired color.

2. The plastic color blender of claim 1 further comprising:
a. said base resin material reduced to a molten flow in said plasticizing portion;
b. said metering device intermediate said plurality of differently colored color additives and plasticizing portion; and
c. said controller causing said metering device to selectively dispense at least one of said plurality of differently colored color additives into said molten flow in said plasticizing portion for mixing therewith in said plasticizing portion such that said base resin material becomes a desired color.

3. The plastic color blender of claim 1 further comprising:
a. a throat portion intermediate said feed portion and said plasticizing portion;
b. said metering device intermediate said plurality of differently colored color additives and said throat portion; and
c. said controller causing said metering device to selectively dispense said at least one of said plurality of differently colored color additives into said throat portion for mixing with said base resin material prior to said base resin material being reduced to a molten flow in said plasticizing portion.

4. The plastic color blender of claim 1 further comprising:
a. said controller receiving a first signal from said plastic processing machine, said first signal indicative at least of a throughput rate of said plastic processing machine; and
b. said controller causing said metering device to dispense selectively said at least one of said plurality of differently colored color additives in a correct proportion to obtain said desired color and in a correct volume to match said throughput rate of said plastic processing machine.

5. The plastic color blender of claim 1 further comprising:
a. a color checking device disposed subsequent said plasticizing portion and in communication with colored base resin material; and
b. said color checking device determining whether said colored base resin material has a color matching said desired color.

6. The plastic color blender of claim 5 further comprising:
a. said controller receiving a second signal from said color checking device, said second signal indicative of whether said color matches said desired color; and
b. said controller causing said metering device to adjust dispensation of said at least one of said plurality of differently colored color additives to cause said color to match said desired color.

7. The plastic color blender of claim 1 further comprising a mixer subsequent to said plasticizing portion for further mixing said at least one of said differently colored color additives with said base resin material after said base resin material has been reduced to a molten flow in said plasticizing portion.

8. The plastic color blender of claim 1 further comprising a mixer intermediate said metering device and a point at which said at least one of said plurality of differently colored color additives are selectively dispensed into said base resin material.

9. The plastic color blender of claim 1 further comprising said metering device being a plurality of metering devices each associated with a respective one of said plurality of differently colored color additives.

10. A method of making colored resin material comprising:
a. providing a plurality of differently colored color additives in selective communication with a base resin material to be colored thereby; and
b. selectively dispensing at least one of said plurality of differently colored color additives into said base resin material to cause said base resin material to become a colored resin material having a desired color.

11. The method of claim 10 further comprising:
a. determining whether a color of said colored resin material matches said desired color; and
b. adjusting said dispensing responsive to said color of said colored resin material not matching said desired color.

12. The method of claim 10 further comprising selectively dispensing at least one of said plurality of differently colored color additives into said base resin material for mixing therewith prior to reducing said base resin material to a molten state.

13. The method of claim 10 further comprising selectively dispensing said at least one of said plurality of differently colored color additives into said base resin material for mixing therewith subsequent to reducing said base resin material to a molten state.

14. The method of claim 13 further comprising mixing said molten base resin material after said at least one of said differently colored color additives has been dispensed therein.

15. The method of claim 10 further comprising mixing said at least one of said differently colored color additives prior to dispensing into said base resin material.
